(19) United States
(12) Patent Application Publication
(10) Pub. No.: US 2022/0350814 A1
(43) Pub. Date: Nov. 3, 2022

(54) INTELLIGENT DATA EXTRACTION

(71) Applicant: Harmonate Corp., Austin, TX (US)

(72) Inventors: Chris Owen, Los Gatos, CA (US); Richard Scheffrin, Georgetown, TX (US); Kevin Walkup, Johnson City, TX (US)

(21) Appl. No.: 17/243,800

(22) Filed: Apr. 29, 2021

(51) Int. Cl. G06F 16/25; G06F 16/28; G06N 3/08

(52) U.S. Cl. CPC G06F 16/258; G06F 16/285; G06F 16/254; G06N 3/08

(57) ABSTRACT

Data from multiple data sources, and in multiple different formats, can be processed accurately and automatically using an intelligent data extraction system. Input data can be processed using a first neural network to infer a classification. Based at least in part upon this classification, a processing workflow can be generated that includes a number of different analytical tools (such as engines, tools, and services) that are able to accurately identify and extract different types of data. Candidate results from these tools can include values for determined attributes, along with associated confidences in those values. An intelligent selection engine, which may also include a neural network, can analyze these values and confidences to select the appropriate value(s) for each of these attributes from the input data. The selected and merged data may be stored using a determined description language, in order to provide for consistent output and presentation of the extracted data.

### BACKGROUND

Data from different sources can come in many different formats, such as in document, worksheet, or database formats. The data itself may be in different forms as well, such as numerical or alphanumerical, in different languages, or in different fonts or styles (including handwritten data). Further still, the attributes assigned to these values may be different for different sources, or even for different data input from a single data source. In situations where it is desirable to aggregate this data in a consistent way, such as may be useful for reporting or data analysis, this wide variety in data input creates significant challenges. Often, at least a significant amount of data must be analyzed and input manually, which can be costly, time-consuming, and error prone. Even for systems that attempt to automate such data input, these systems are generally limited to specific formats or styles of data input, which may not be optimal or even appropriate in situations where input may vary significantly.

### BRIEF DESCRIPTION OF THE DRAWINGS

Various embodiments in accordance with the present disclosure will be described with reference to the drawings, in which:

FIG. 1 illustrates an example approach to extracting and merging data that can be utilized in accordance with various embodiments.

FIG. 2 illustrates an example extraction and merging pipeline that can be utilized compared in accordance with various embodiments.

FIGS. 3A, 3B, and 3C illustrate portions of an example extraction and intelligent selection process that can be utilized in accordance with various embodiments.

FIG. 4 illustrates an example intelligent extraction of data that can be utilized in accordance with various embodiments.

FIG. 5 illustrates an example environment in which aspects of various embodiments can be implemented.

FIG. 6 illustrates example components of a computing device that can be used to implement aspects of various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the intelligent analysis and extraction of data from a variety of data sources in a variety of different formats. In particular, various approaches utilize multiple analytical engines, or other such components or services, to analyze data contained in received input, as may take the form of documents, files, email, data tables, and the like. These analytical engines can attempt to determine types of attributes (e.g., name, title, age, address, etc.) contained within the input data, as well as the values of those attributes. Each analytical engine can generate output including its determined or inferred attributes and values, in at least one embodiment, along with a confidence score for each. An intelligent merging system or service can then select the appropriate values for each of these attributes from among the various candidate values produced by the analytical engines, such as by using a voting process. In some embodiments, data about the data (metadata) will be gathered through the analysis steps, stored for future processing, and then voted on by an appropriate engine to determine the most accurate entity values. In some embodiments, a voting process can be utilized wherein a value with the highest confidence is selected for each identified attribute, where that attribute is also identified with at least a minimum confidence. In other embodiments, this candidate data may be provided as input to a neural network, or other machine learning-based implementation, trained to infer the appropriate value for each attribute, where selected values may be based not only on confidence, but also based upon factors such as a type of attribute or input document, as well as a performance-based weight for an analytical engine, producing that candidate value, with respect to the an aspect of the input data (e.g., for handwritten data or for unstructured data). In at least one embodiment, a common description language can be used to store data from these various data inputs in a structured and consistent way. Some embodiments may require that a common description language be used for all such expression. Such an approach enables data in various formats from various sources to be reliably and automatically processed, with the data then being presented in a standardized way that allows for consistent reporting, analysis, or other such usage.

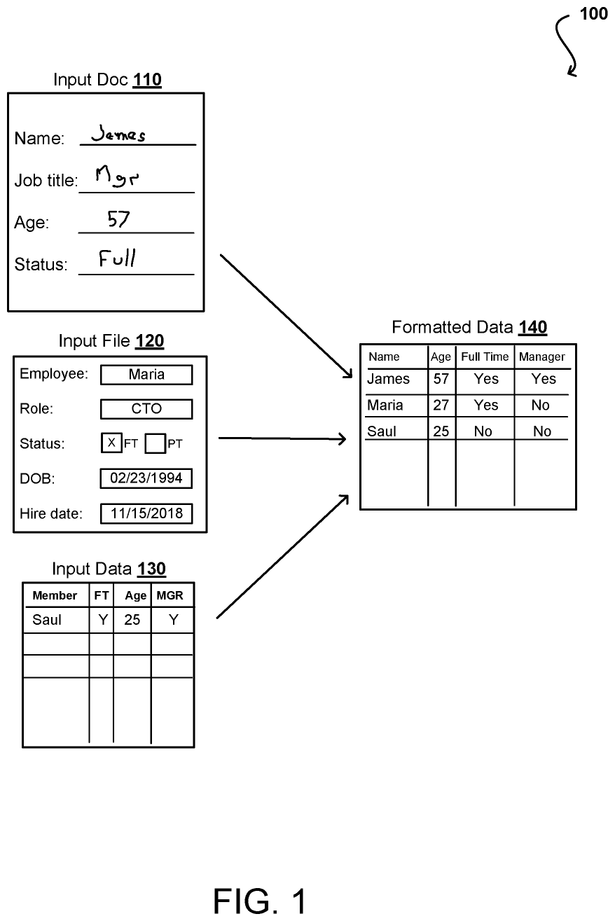

FIG. 1 illustrates an example of such an intelligent data extraction approach. As illustrated, there are three different instances of input, including an input document 110, an input file 120, and an input table or worksheet 130. As illustrated, the various inputs express the data in different ways. Initially, it can be seen that the data is expressed in different formats, with different arrangements and forms. For example, the input document 110 includes handwritten data. Different instances express age in different ways, such as an age value or a date of birth that can be used to determine age. Also, different instances utilize different attribute titles to express similar types of attributes, such as a “name” attribute being expressed as name, employee, and member in this example. The different instances may also have values for less than all target attributes, or more than the target attributes (or attributes of interest). For example, the input file 120 also includes a “hire date” attribute. In some embodiment this data can be captured and stored as well, so that no data is lost, while in other embodiments data that is not of interest can be discarded or treated separately. As illustrated, an intelligent extraction process can analyze each of these inputs, and can accurately extract and identify the respective attributes and values. This provides for the accurate ingesting of very different document or file types from potentially very different sources. Such an approach enables multiple different data sets, which may include data in different formats and with different expressions, to have the data accurately identified and extracted. After data (e.g., one or more attribute values) is extracted from these input documents and expressed in a common format, or using a common dictionary, this data can then be stored together into a single expression, such as data table 140, where values for similar attributes can be expressed in a common format in a common language. This single output expression can then be used for purposes such as reporting, presentation, or statistical analysis, among other such options. In other embodiments, this data may be stored separately but queries or reports can be run across any, or all, of this data.

In at least one embodiment, value selection can be performed using an intelligence engine. An intelligence engine can be utilized that can, through a robust process, recursively analyze data of disparate sources to determine the most accurate value for key entity attributes. The source can be analyzed by a determined workflow process, with individual steps in the process employing specific processes to perform tasks, such as to scan and analyze the underlying data. Such a process can culminate in a final entity-merging step that can employ one or more artificial intelligence (AI) or machine-learning processes, logic processes, and/or rules-based configurable processes to determine the most accurate expected result for any given attribute found in the source document. Data indicating the source data, individual analysis steps, and confidence in the end results can be made available for consumption in a specific description language document, where all data is expressed according to an identified description language.

In at least one embodiment, a description language document, such as a document in a Harmonate Description Language (HDL) from Harmonate Corp., is a document that is produced by a process of an intelligence engine, such as a Hydra Intelligence Engine also from Harmonate Corp., to gather data about all analyzed data sources. Such documents will be referred to as HDL documents hereinafter for purposes of convenience, but it should be understood that such documents may take other forms or store data in other languages or formats within the scope of the various embodiments. A goal of at least one embodiment is to analyze the data from multiple angles and dimensions in order to be able to use that data, as well as metadata describing that data, to determine the best or most accurate value, or value with the highest confidence, for each of the entity's attributes. Such a document can be used to track the entire process and use those analyses as a script for future machine learning against the original source data and the resulting analysis. Data in the document can be hierarchal in nature in at least some embodiments, with sections for results from different steps in the process. Each level in the hierarchy may correspond to a different section, or there may be hierarchies within a given section. A dictionary of various data types can improve over time as more data is processed, and in at least some embodiments this dictionary can be exposed to users so that those users can more quickly identify or locate specific data of interest.

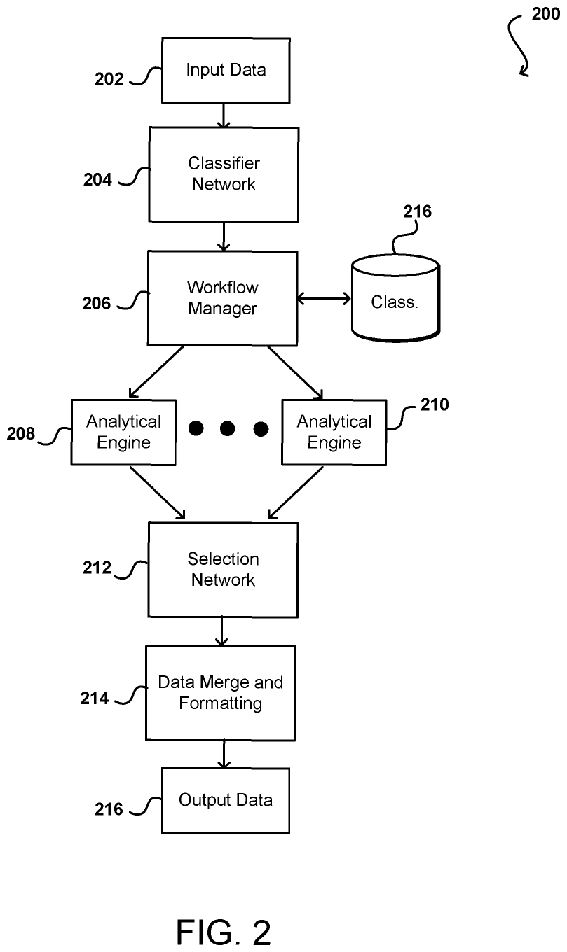

FIG. 2 illustrates an overview of components in an example intelligent data extraction system 200 that can be utilized in accordance with various embodiments. In this example, input data 202 can be received to a classifier network 204. A classifier network in at least one embodiment can be used for automatic document classification, such as may involve content-based assignment of one or more predefined, and easily understood, categories (e.g., topics) to documents, files, or other such data sets or groupings. Such classification can make it easier to locate or intelligently extract the relevant information at the right time, as well as to filter and route documents directly to users or other such recipients.

In some embodiments the data may first be received to an interface (not illustrated), such as an application programming interface (API), and may undergo at least some pre-processing as discussed elsewhere herein. There may also be other, additional, alternative, or fewer components in such a system as discussed or suggested elsewhere herein, and as may be understood by one of ordinary skill in the art in light of the present description. In this example, the classifier network may be a rules-based or machine learning-based service, among other such options, which can attempt to classify the input data 202. This can include, for example, determining whether the input data is a handwritten document, a conventional worksheet, an email message in a specific language, or a file of unstructured data, among other such options. In at least one embodiment, such classification can help to identify services to process this data, based upon historical performance data, or weightings to be applied to values output from those services, among other such options. In some embodiments, such classification of input data may not be necessary or utilized.

The data can be passed to a workflow manager 206 to determine a workflow for the processing of this input data. In at least one embodiment, this can include determining which of a plurality of available services should process the input data. For example, if the document includes handwritten data then there may be services that perform well with handwritten data and services that do not, and an appropriate selection can be made. In some embodiments, a workflow manager may attempt to have all available services analyze at least a portion of the input data, and can manage the workflow to cause the data to be provided, or made available, to the various services, as well as causing the services to process the data and ensure that any results of those services are passed along to a selection network 212 or other intended recipient. In some embodiments, a workflow manager may use a rules-based approach to determine which engines or services should process an instance of input data, such as may be based upon an inferred classification of the data, or another selection approach can be utilized, such as a mixture of experts or other such approach. In at least one embodiments, queues or workflow buffers may be used between steps or components along the workflow to hold data until the next step or component is ready to process that data.

As discussed in more detail elsewhere herein, a variety of analytical engines 208, 210, processes, systems, or services can be used to analyze input data and attempt to determine types of attributes included in the input data, as well as values indicated for those attributes. Example engines can include different types of data analysis capabilities, such as optical character recognition or handwriting recognition, pattern recognition, computer vision, speech to text conversion, and the like. Each service can also have various strengths and weaknesses when it comes to processing different types of data or data abstractions. In at least one embodiment, each such service or engine will output values, attributes, and other such data that was determined for the input data by that service or engine, along with individual or overall confidence values for that output. In at least one embodiment, an intelligent data extraction system can provide a framework for adding, or plugging in various services, engines, or modules to use for processing. In some embodiments, one or more of these services may be offered by a third party system over at least one network.

The results from the various analytical engines 208, 210 or services can be provided, or otherwise made available, to a selection network 212 (or intelligence engine, etc.) in this example. As discussed in more detail elsewhere herein, a selection network (or other such system or service) can analyze the values for each attribute as reported by the various engines or services, and can select, vote, infer, or otherwise determine which value(s) to use or accept for each attribute. This may include a value with a highest associated confidence value, or may include an inferred optimal value based on weightings or inference by a neural network, among other such options. Other rules, heuristics, or algorithms for selecting from among candidate values can be used as well within the scope of the various embodiments. In this example, a separate data merge and formatting component 214 can be used to take the selected values from the selection network 212 and use those values to produce an output document, or other such format, that contains all the selected data presented in a consistent format using consistent terminology, such as may correspond to a determined description language. In some embodiments, at least some of this functionality may be performed by the selection network service 212. A single output 216 can be generated that includes the selected data in the target format and description language, where that output can be a new instance or added to an existing instance, such as a new row, column, or table in a database or worksheet.

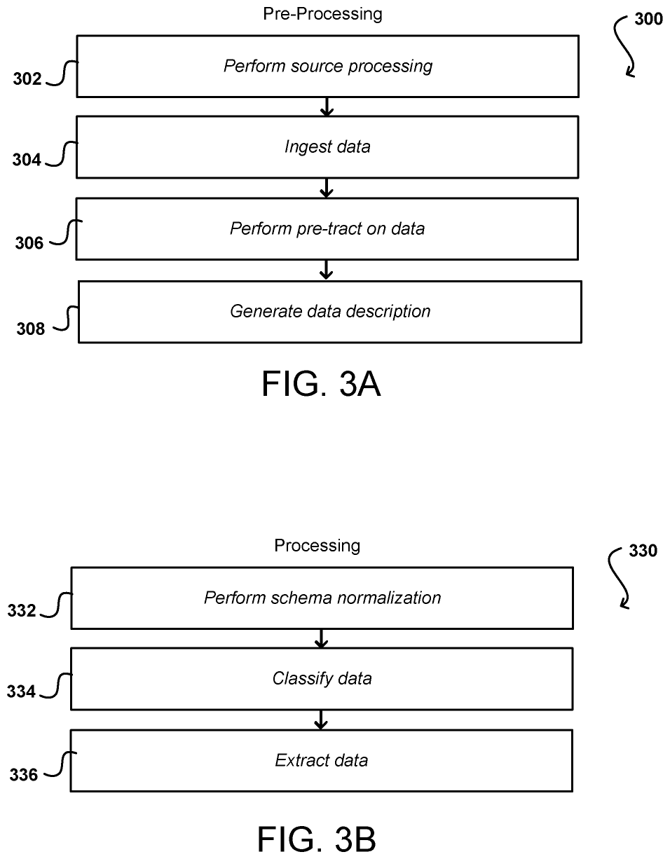

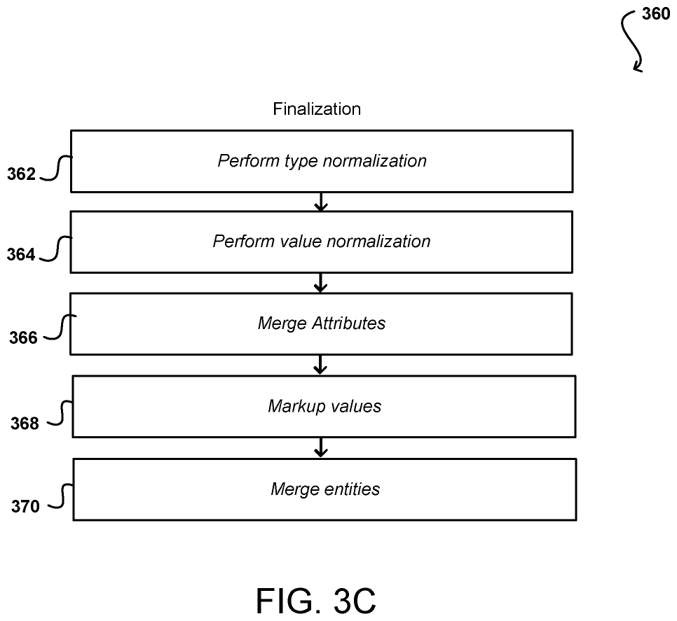

FIGS. 3A through 3C illustrate portions of an example process for intelligent extraction of data that can be utilized in accordance with various embodiments. It should be understood that for this and other processes discussed and suggested herein that there can be additional, fewer, or alternative steps performed in similar or alternative orders, or at least partially in parallel, within the scope of the various embodiments unless otherwise specifically stated. In at least one embodiment, data received for processing will first undergo pre-processing 300, such as may include steps outlined in FIG. 3A. In this example, received data first goes through source processing 302. In an example source processing step, data sources that comprise a storage model, where the document is attached to the source, can be processed first in order to export the data from the storage model to be reprocessed in a separate ingestion process step, tracking the source of the original data as well as the source of the attached data. This data can be appended to the HDL document, such as in a container section, to track the source of any ingested data. In this way, a data extraction system can be enabled to track the container source and its metadata (such as an email, the sender's name and address, or a date/time of the email), as well as the attached documents or data (such as that container email containing a number of attached text documents). Each separate source document in a container may result in the generation of a separate HDL document with the same container source for each document.

At least some of the data will also go through ingestion 304. A data ingestion step allows data to be gathered from multiple disparate data sources and output in a hierarchical model describing the imported data. Any metadata describing the origin data (such as filename, date/time of creation) can be added in a relevant section of the HDL document. As part of an example ingestion process, the HDL document section for origin data can be populated with tabular data sources, such as a database tables or spreadsheet data, with distinct rows and columns into a set of such table records with any clarifying metadata attached to that table, such as column names or row labels. The output of this step can be a set of hierarchical data sources and tabular data comprised from the original data sources. Data that is described as hierarchical in nature, such as results of an API call that returns a document description multiple levels of data, may be translated to an origin data section of the HDL document. Nothing more will be done with the data in this step in this example process. Data of a non-tabular format, such as a filled form will only be attached to the origin data section with appropriate metadata describing the source data. Processing of this type of data source will occur later in the process pipeline.

The data can also have pre-tract processing 306 performed in at least some embodiments. An example pre-tract step in such a process can include any number, selection, or variety of services of similar or different types that can validate and/or clean the data imported in the ingestion stage. In addition, services may add basic metadata describing the data that will service the processing engine later in the process. The results of the pre-processing validation services can be attached to an origin (or similar) section of the HDL to later be able to know the validity of the origin data.

For tabular data sources, pre-processing can be meant to validate whether an individual data source meets a viable threshold of data integrity. This level of confidence, given the context in which the data is presented, can be saved as an attribute in the HDL document along with the data. For hierarchical data types, this can included validating that received data is of a correct format for further processing. As an example, data of a JSON (JavaScript Object Notation) type can be processed to validate that the data is balanced, and that the syntax is valid. For freeform data sources, data that derives from document types can be validated to verify file size is of an acceptable range or to validate the extension of the file matches the expected file's internal data, as an example. Any document failing validation can be marked as such for further processing as part of an example workflow. In addition, services can exist to clean the documents before further processing, such as for removal of password protection or removal of a watermark in that document. Data describing any changes made in a cleaning stage can be added to the HDL document to indicate those changes to the document. Also, both the source document and the modified document can be stored for future use as a machine learning source. Metadata describing the different versions of the source can be added to the HDL document in an origin (or similar) section. This example process can also include one or more services that add metadata describing the data, and can be run to add that metadata to the HDL to describe the origin data. As an example, counting the number of pages in a printed document can result in that number being added for that document in an origin (or similar) section of the HDL document.

As a final step in this example pre-processing flow, a data description can be generated 308. This example process step can employ a number of services to analyze the ingested data to determine the nature of the data. These services can work independently to analyze the nature of the data and identify patterns (including anomalous patterns) in the data contained in the document. The available services can be continuously rated for applicability to each document type and source so that only appropriate services will be used to analyze and extract the document data. This process can create a multiplicity of parallel processes to transform the data until merging back into common entities in the Entity Merging stage below. For tabular, hierarchical data sources, services can be employed to analyze the nature of the data to group into hierarchal data types for later analysis. For freeform data sources, such as for document-based data, a number of services can be employed to give the metadata necessary to further breakdown the data into their inherent data types. Data derived from these services can be added to the HDL document in an analyses (or similar) section. These services can have the ability to read document data, imaged-based data and handwritten data, in addition to any other form of data developed in the future that can be analyzed.

After any such pre-processing, the data can be processed in a processing flow 330 or pipeline, such as illustrated in the example of FIG. 3B. In a first step of the process, the data can have schema normalization performed. Schema normalization can be used to translate the ingested data into a hierarchal set of standard data types that represent the data only from the original source and stored, for example, in a data blocks or similar section of the HDL document. As a basic example, a printed document such as a book can be represented in a top-down hierarchical model as:

Book->Page->Paragraph->Sentence

Such a step can be used to standardize any disparate data source into a common data language that can describe all aspects of the data. Attached to the data models in the HDL will be attributes that would describe the data's place in the original data source. As an example, a table can have rows and columns of child data types in the hierarchy of that data model. Additional attribution could describe the quality of the data, such as the size or the font of the word on a page of a book. The data types can reflect the kind of source data, as implied in this description. A book can contain pages, paragraphs, diagrams, sentences, and words, while a table will contain rows and columns. Each engine analysis from a data description process can generate its own data-only picture and be stored in a data blocks (or similar) section. The data types can be standard across all engine outputs, but will not be consistent across engines of the HDL. As an example, one engine might analyze pages only while another engine will look at an entire document as only a large set of words, not making any further breakdowns, so the data blocks output will reflect how the data was analyzed in the data definition process.

As a next step in this example process, the data can be classified 334. This example process step can include, or utilize, various services that can attempt to categorize the data grouping of the data that was previously built out in the schema normalization step to attempt to determine the distinct data type of each group. Each container grouping in the data block (or similar) section can be analyzed by several services to attempt to estimate the known type of that group against known patterns. Entire documents can be classified with an expected document type based on algorithms that will analyze factors such as keywords and anomalous patterns, such as by various pattern detection algorithms. This step can be integral, in at least some embodiments, to understand what each data group represents as a distinct construct, as may represent a business objective for more specific analysis in further steps in the process. Examples based on a printed document could be the specific form type of a tax document or one page in a document that represented an expected type. Any metadata describing the type of each group can be appended to the group in a data block (or similar) section of the HDL document.

A next step in this example process can be to extract the data 336. Data extraction in this context can involve the use of data from an analyses (or similar) section of the HDL to attempt to find relevant entities from the data block (or similar) section of the HDL and the expected data types as determined in the classification stage of this example process. Each service can have a single responsibility to scan the entire document, using the data that has been previously gathered about the types of the data, to attempt to find patterns in each data element. Examples can include services to scan a document to search for phone numbers, in any of their various patterns, and mark that data element as a probable phone number. Another example is currency, where a document can be scanned to identify data elements with patterns that match currency patterns. In addition, services can attempt to determine whether two elements hold a key-value relationship, such as a label with the text “phone number:” followed immediately with a value such as “555-555-5555”. The data block for the text “phone number” can be marked with the metadata as a label with a relationship to the value (e.g., the phone number value) that the label is associated with.

Data having gone through such a processing pipeline may then be processed using a finalization process 360, such as the process illustrated in FIG. 3C. A first step in this example process is to perform type normalization. Type normalization can be used to analyze the data and metadata as determined by the previous process steps, for those items marked as entities by the extraction process. Given the known document type, page type, and other data gathered in the classification stage, labels can be marked as known types based, at least in part, upon a canonical data dictionary of label types. One label could possibly be marked with multiple standard data types.

Another step in this example finalization process involves performing value normalization 364. Value normalization may be somewhat similar to label normalization as it can encompass a similar process to use data gathered in the previous steps to determine the expected value type and format of a data element. Value types can have a canonical form so they may be later compared to the results from other process flows. For example, the format of a US phone number value type could be expressed in many different ways such as “(408) 408-8080”, “408-408-8080”, “+1 (408) 408-8080” which all would resolve to the correct, known type. If there is an established relationship to other known data in a data blocks (or similar) section of the HDL, that information can be used to increase accuracy and confidence in the given type of a value. As previously presented, a label stating “Total Income:” associated directly with an entity that appears to be a currency value, can have its confidence score increased by the association with a label type expecting a currency value. Any familial relationships in the data can be used to validate the expected value type of the data.

In at least one embodiment, attributes can be merged 366 through an associative mapping step. An attribute merging process can gather all pertinent data as part of a label normalization and value normalization process step, and can create a set of data dictionaries of key-value pairs, such as one per data block (or similar) result. Once the data has been gathered, that dictionary can be created in a separate section in the HDL, such as an entities (or similar) section. The data can consist of an established, known label type, such as a “First Name” label type. Other possible values for that label may also be listed, such as with one or more pointers back to the data block representing the entity.

Once a document has been classified, and its attributes normalized, the data for that document can be processed by two or more (and potentially several) artificial intelligence, machine learning, or programmatic processes to attempt to identify, for example, associations between attributes. These may be based on factors such as geometrical positioning and distance, hierarchical relations including parent-child and other familial linkages, or internal consistency based on literal or translated equivalency. Each of these (and other such) associations can have a calculated effect on the confidence scores of the resulting data. Data, which is found more often in the document, but of the same type, and containing the same value will be considered more accurate. For example, a first name appearing 18 times in a document, with 17 of the values agreeing will be considered more likely to be accurate.

A next step in this example process can be to perform value markup 368. A value markup process can involve further analyzing the data (such as in an entities section) of the HDL, analyzing each entity in the data dictionary and, given the resolved data type of each value, the system can attach metadata describing the data in greater detail. These values can service the end consumer to give more texture to the data being extracted by the engine. This metadata can be resolved from internal data stores or from external services. As an example, an entity that has been determined to correspond to an address could be run against an address normalization process to determine an alternate value for that address, which could be added as an alternate value to an entities (or similar) data dictionary in the HDL document.

A final step in this example process can involve a merging of entities 370. After the data has been gathered from the multiple threads of data description services and subsequent processes, for example, a final step in this intelligent extraction process can encompass a set of artificial intelligence, machine learning, and/or procedure-based services to look at each attribute in, for example, an entities section of the HDL document. In at least one embodiment, an overarching voting service can analyze the entire dataset for each attribute and determine the value for that attribute with the highest associated confidence. In other embodiments, machine learning may be used to infer the value for each attribute using the network parameters used for the training of the machine learning. In some embodiments, weightings can be learned for the values output by various services, such as may be learned overall or for specific types of input or data, which can be used with the confidence data to select a value for each attribute. The attributes selected can be from different systems, services, or algorithms for analyzing the data. Once a value is selected for an attribute, that value can be merged with other selected values for other attributes. The merging in at least one embodiment will produce only one set of results for each entity. Each attribute value may also have an associated confidence score showing the confidence that, given the various inputs and determinations, this value is correct for a respective attribute. These attribute confidence scores can roll up into an overall confidence score for the resulting merged entity, such as a document, worksheet, or data table including the selected and merged attribute values.

An advantage of such a system is that it can intake almost any type of document with the data in almost any type of format. A further advantage is that the processing can be done in bulk, with a majority of the processing being done automatically. In the event a document or type of data is unable to be accurately processed, such as by failing to satisfy at least one minimum confidence criterion or threshold, then that document may be flagged for further analysis, such as may involve manual review in at least some instances. Accurate training of such a system, however, should result in few such occurrences.

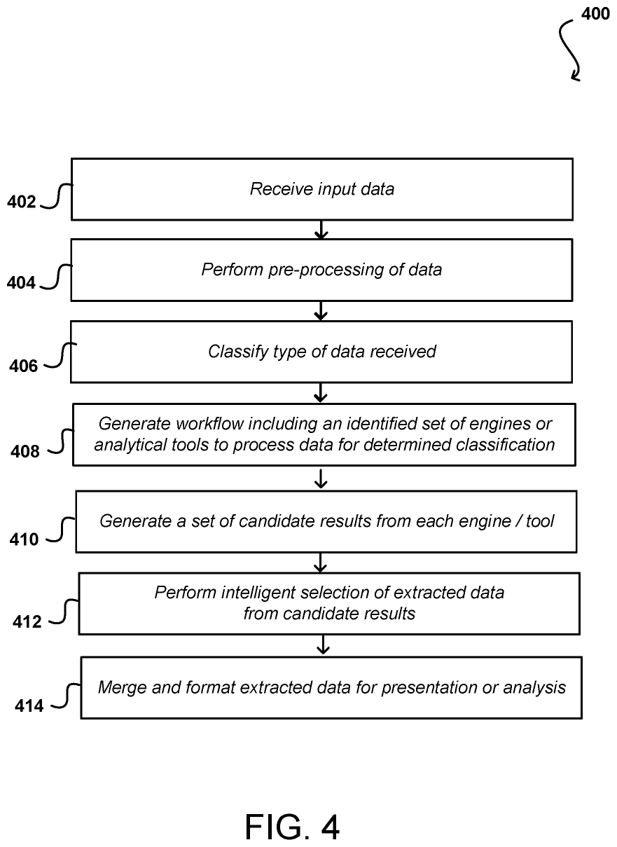

FIG. 4 illustrates another example process 400 that can be utilized in accordance with various embodiments. In this example, at least one set of input data is received 402, where that input data can be of various types or formats, and may include a variety of attribute values in different forms as discussed herein. At least some pre-processing of the data can be performed 404, and the pre-processed data can then be classified 406, or assigned to one of a number of known data classifications. A workflow can then be generated 408 that includes an identified set of engines, services, or analytical tools to process the data, where this set can be identified based at least in part upon the determined or inferred classification. Each of these engines, services, or tools can generate 410 a set of candidate results for the data, such as a set of values for determined attributes, along with associated confidences for those values. An intelligent selection of these candidate results can then be performed 412 in order to determine the appropriate value for each attribute, as may be based at least in part upon the respective confidences. These selected values can then be merged and formatted 414 for presentation or analysis. In at least one embodiment, the data along the way will be written to a document or file using a specified definition language, such that the formatting may be limited to a type of output document that includes, or is based upon, data in the definition language.

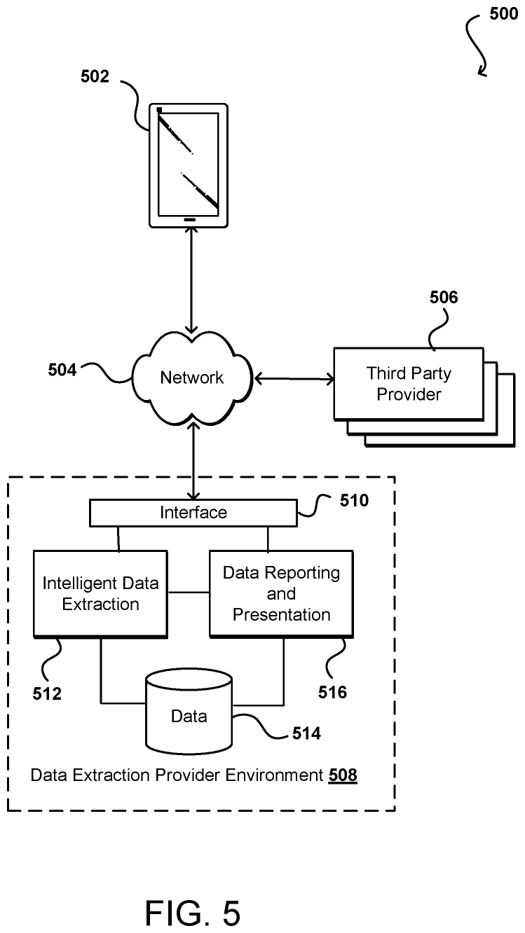

As mentioned, different aspects of various embodiments can be performed in different locations. This can include, for example, portions of the functionality being executed on a client device, network or cloud server, or third party provider system, among other such options. FIG. 5 illustrates an example environment 500 in which such aspects may be implemented. In this example, a user may utilize a client device 502 to request, provide, or obtain data from a data extraction provider environment 508. A user may use the client device 502 to provide input data to be analyzed, or to request output data that has already been analyzed, or may use the client device to perform at least a portion of the analysis. The client device 502 may communicate with the data extraction provider environment 508 over at least one network 504, such as the Internet or a cellular network. The output data may include any appropriate data, or other content, generated or obtained by one or more resources of the data extraction provider environment, such as by obtaining input data from a third party provider 506. In at least one embodiment, this third party data may include input data to be analyzed, or candidate extraction data performed on a specified set of data to be processed, among other such options. Any data sent to, or from, the data extraction provider environment can pass through an interface layer 510, as may include a set of APIs or other such interfaces used for transmitting data, instructions, or other such content.

In this example, the data can be directed to an intelligent data extraction system 512 to analyze input data, identify accurate attribute values, and provide that data in a consistent, formatted output, as may be stored to a data repository 514 of the data extraction provider environment 508. As mentioned, this can include using multiple services or engines to analyze the input data, then select the appropriate values to use for each of those attributes. In response to a request for this output data, a data reporting and presentation component 516, system, or service can obtain the relevant data from the data repository 514 and provide that data over the network(s) to the requesting client device 502, or another specified recipient. In at least some embodiments, the data reporting and presentation component 516 may first verify that the client device is authorized to receive that data, such as by ensuring a valid account, credential, or user identifier associated with the client device 502 or the request.

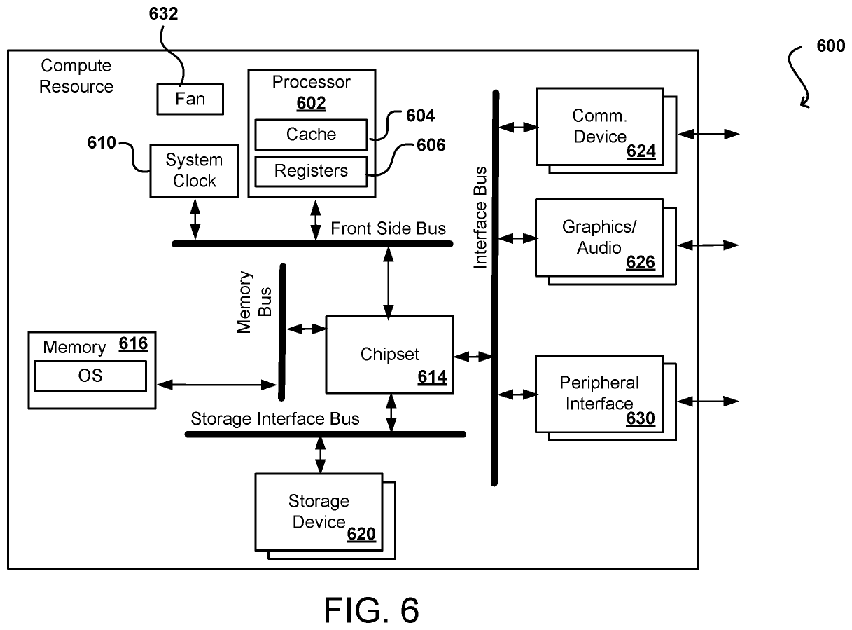

Computing resources, such as servers or personal computers, will generally include at least a set of standard components configured for general purpose operation, although various proprietary components and configurations can be used as well within the scope of the various embodiments. FIG. 6 illustrates components of an example computing resource 600 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 600 (e.g., a desktop or network server) will have one or more processors 602, such as central processing units (CPUs), graphics processing units (GPUs), and the like, that are electronically and/or communicatively coupled with various components using various buses, traces, and other such mechanisms. A processor 602 can include memory registers 606 and cache memory 604 for holding instructions, data, and the like. In this example, a chipset 614, which can include a northbridge and southbridge in some embodiments, can work with the various system buses to connect the processor 602 to components such as system memory 616, in the form or physical RAM or ROM, which can include the code for the operating system as well as various other instructions and data utilized for operation of the computing device. The computing device can also contain, or communicate with, one or more storage devices 620, such as hard drives, flash drives, optical storage, and the like, for persisting data and instructions similar, or in addition to, those stored in the processor and memory. The processor 602 can also communicate with various other components via the chipset 614 and an interface bus (or graphics bus, etc.), where those components can include communications devices 624 such as cellular modems or network cards, media components 626, such as graphics cards and audio components, and peripheral interfaces 630 for connecting peripheral devices, such as printers, keyboards, and the like. At least one cooling fan 632 or other such temperature regulating or reduction component can also be included as well, which can be driven by the processor or triggered by various other sensors or components on, or remote from, the device. Various other or alternative components and configurations can be utilized as well as known in the art for computing devices.

At least one processor 602 can obtain data from physical memory 616, such as a dynamic random access memory (DRAM) module, via a coherency fabric in some embodiments. It should be understood that various architectures can be utilized for such a computing device, that may include varying selections, numbers, and arguments of buses and bridges within the scope of the various embodiments. The data in memory may be managed and accessed by a memory controller, such as a DDR controller, through the coherency fabric. The data may be temporarily stored in a processor cache 604 in at least some embodiments. The computing device 600 can also support multiple I/O devices using a set of I/O controllers connected via an I/O bus. There may be I/O controllers to support respective types of I/O devices, such as a universal serial bus (USB) device, data storage (e.g., flash or disk storage), a network card, a peripheral component interconnect express (PCIe) card or interface 630, a communication device 624, a graphics or audio card 626, and a direct memory access (DMA) card, among other such options. In some embodiments, components such as the processor, controllers, and caches can be configured on a single card, board, or chip (i.e., a system-on-chip implementation), while in other embodiments at least some of the components may be located in different locations, etc.

An operating system (OS) running on the processor 602 can help to manage the various devices that may be utilized to provide input to be processed. This can include, for example, utilizing relevant device drivers to enable interaction with various I/O devices, where those devices may relate to data storage, device communications, user interfaces, and the like. The various I/O devices will typically connect via various device ports and communicate with the processor and other device components over one or more buses. There can be specific types of buses that provide for communications according to specific protocols, as may include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device may be used, for example, as a server in a server farm or data warehouse. Server computers often have a need to perform tasks outside the environment of the CPU and main memory (i.e., RAM). For example, the server may need to communicate with external entities (e.g., other servers) or process data using an external processor (e.g., a General Purpose Graphical Processing Unit (GPGPU)). In such cases, the CPU may interface with one or more I/O devices. In some cases, these I/O devices may be special-purpose hardware designed to perform a specific role. For example, an Ethernet network interface controller (NIC) may be implemented as an application specific integrated circuit (ASIC) comprising digital logic operable to send and receive packets.

As discussed, different approaches can be implemented in various environments in accordance with the described embodiments. As will be appreciated, although a network- or Web-based environment is used for purposes of explanation in several examples presented herein, different environments may be used, as appropriate, to implement various embodiments. Such a system can include at least one electronic client device, which can include any appropriate device operable to send and receive requests, messages or information over an appropriate network and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that may need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle® , Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
receiving an input document including a set of input data;
analyzing the input data using a plurality of analytical services, individual services of the plurality of services utilizing different approaches for identifying and extracting the input data;
receiving, from the plurality of analytical services, candidate values for identified attributes of the input data, the candidate values having associated confidence values;
analyzing, using a selection mechanism, the candidate values and the associated confidence values to attempt to select one of the candidate values for each identified attribute; and
merging the selected candidate values into a single output document expressing the input data in a determined format.

2. The computer-implemented method of claim 1, wherein the selection mechanism includes a voting algorithm for selecting one of the candidate values for each identified attribute based primarily on the associated confidence values.

3. The computer-implemented method of claim 1, wherein the selection mechanism includes a neural network trained to infer the selected candidate values for the identified attributes.

4. The computer-implemented method of claim 1, further comprising:
expressing the selected candidate values using a specified description language with a common dictionary for use across all types of the input data.

5. The computer-implemented method of claim 1, further comprising:
analyzing the input document using a trained classifier network to infer a class of the input document.

6. The computer-implemented method of claim 5, wherein the plurality of analytical services are selected, from a pool of analytical services, based at least in part upon the inferred class of the input document.

7. The computer-implemented method of claim 5, further comprising:
generating a workflow to cause the input data to be processed, at least partially in parallel, using the plurality of analytical services, wherein the workflow is generated based at least in part upon the inferred class of the input document.

8. The computer-implemented method of claim 7, further comprising:
storing data, or metadata, for each stage of the workflow to a respective section of the output document.

9. The computer-implemented method of claim 5, further comprising:
flagging the input document for further review if one or more of the associated confidence values, or an overall confidence threshold for the values, does not at least satisfy a minimum confidence threshold.

10. The computer-implemented method of claim 5, further comprising:
enabling the output data to be provided in a determined format along with output data for other input from one or more other sources in one or more other input formats.

11. A computer-implemented method, comprising:
receiving a plurality of data inputs in a plurality of different forms;
processing the data inputs using a plurality of different analytical services to attempt to identify candidate values for identified attributes in the data inputs;
utilizing a trained neural network to infer, from among the candidate values, optimal values for the identified attributes in the data inputs; and
merging the optimal values for the identified attributes into a single output, wherein the optimal values are expressed using a determined description language.

12. The computer-implemented method of claim 11, wherein the different analytical services further determine associated confidence values for each of the candidate values, and wherein the trained neural network is to infer the optimal values further based upon the associated confidence values.

13. The computer-implemented method of claim 11, further comprising:
analyzing the different data inputs using a trained classifier network to infer classes for the different data inputs, wherein the plurality of different analytical services is selected based at least in part upon the inferred classes.

14. The computer-implemented method of claim 11, further comprising:
generating a workflow to cause the different data inputs to be processed, at least partially in parallel, using the plurality of different analytical services.

15. The computer-implemented method of claim 14, further comprising:
storing data, and any associated metadata, for each stage of the workflow to a respective section of the single output.

16. A system, comprising:
at least one processor; and
memory including instructions that, when executed by the at least one processor, cause the system to:
receive a plurality of different data inputs in a plurality of different forms;
process the data inputs using a plurality of different analytical services to attempt to identify candidate values for identified attributes in the data inputs;
utilize a trained neural network to infer optimal values for the identified attributes in the data inputs; and
merge the optimal values for the identified attributes into a single output, wherein the optimal values are expressed using a determined description language.

17. The system of claim 16, wherein the different analytical services further determine associated confidence values for each of the candidate values, and wherein the trained neural network is to infer the optimal values further based upon the associated confidence values.

18. The system of claim 16, wherein the instructions when executed further cause the system to:
analyze the different data inputs using a trained classifier network to infer classes for the different data inputs, wherein the plurality of different analytical services is selected based at least in part upon the inferred classes.

19. The system of claim 16, wherein the instructions when executed further cause the system to:
generate a workflow to cause the different data inputs to be processed, at least partially in parallel, using the variety of different analytical services.

20. The system of claim 16, wherein the instructions when executed further cause the system to:
store data, and any associated metadata, for each stage of the workflow to a respective section of the single output.
